(19) United States
(12) Patent Application Publication
(10) Pub. No.: US 2008/0038624 A1
(43) Pub. Date: Feb. 14, 2008

(54) Proton-conducting polymer membrane coated with a catalyst layer, said polymer membrane comprising phosphonic acid polymers, membrane/electrode unit and use thereof in fuel cells

(76) Inventors: Jorg Belack, Mainz (DE); Isabel Kundler, Konigstein (DE); Thomas Schmidt, Frankfurt (DE); Oemer Uensal, Mainz (DE); Joachim Kiefer, Losheim am See (DE); Christoph Padberg, Wiesbaden (DE); Mathias Weber, Russelsheim (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/796,551

(22) Filed: Apr. 27, 2007

Related U.S. Application Data
(63) Continuation of application No. 10/570,555.

(30) Foreign Application Priority Data
Sep. 4, 2003 (DE) 10340928.9

(51) Int. Cl. H01M 4/02

(52) U.S. Cl. 429/43

(57) ABSTRACT

The present invention relates to a proton-conducting polymer membrane coated with a catalyst layer, said polymer membrane comprising polymers which comprise phosphonic acid groups and are obtainable by polymerizing monomers comprising phosphonic acid groups, characterized in that the catalyst layer comprises ionomers which comprise phosphonic acid groups and are obtainable by polymerizing monomers comprising phosphonic acid groups.

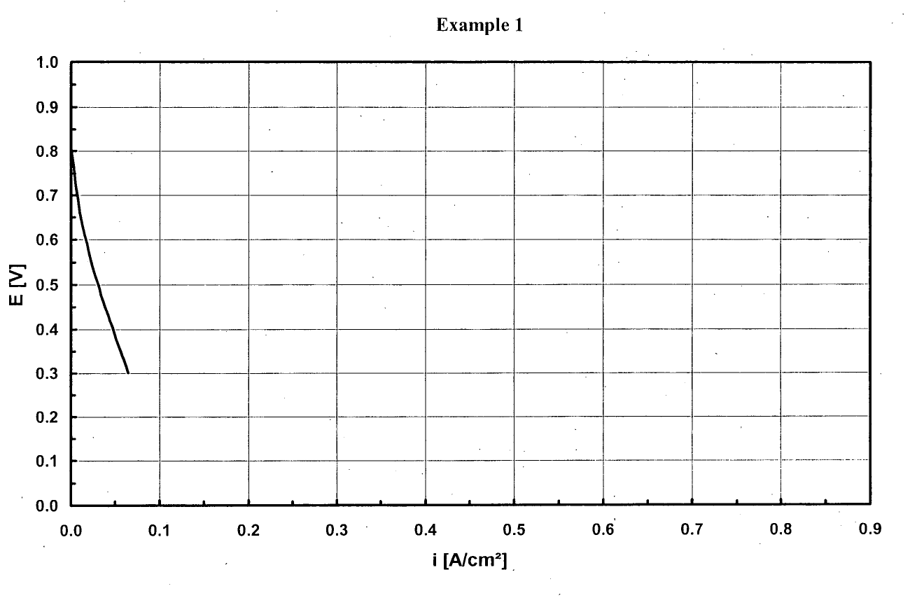

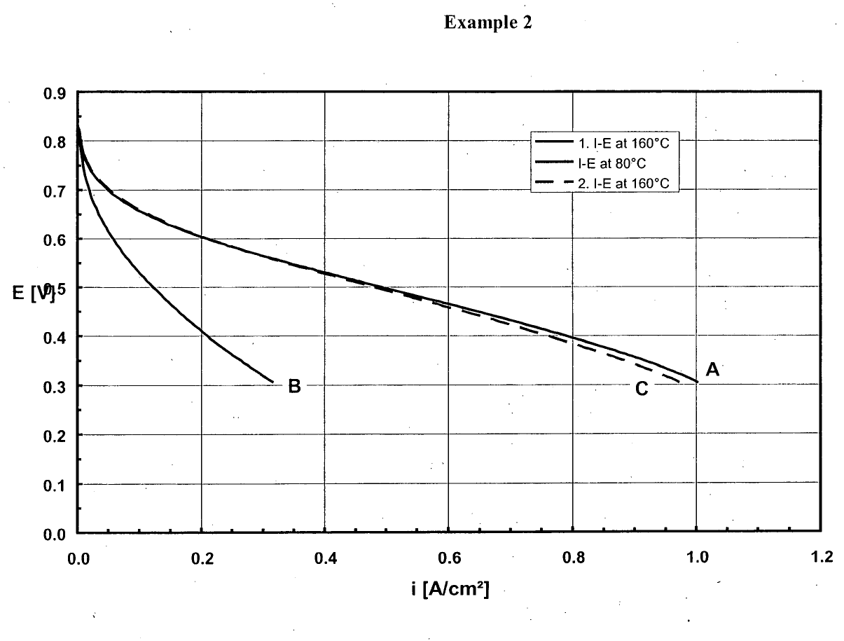

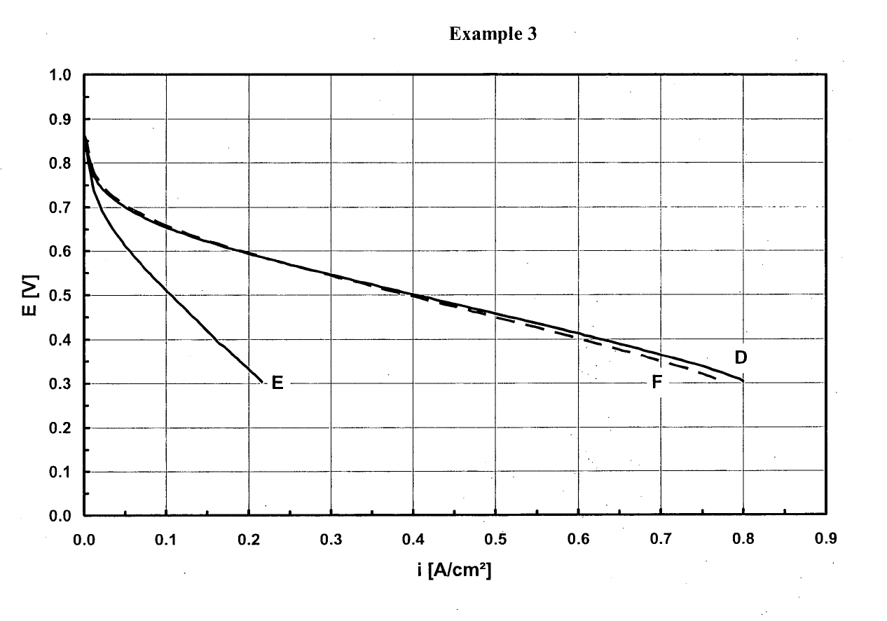

The present invention relates to a proton-conducting polymer electrolyte membrane which is coated with a catalyst layer and comprises polymers comprising phosphonic acid groups, to membrane-electrode units and to their use in fuel cells.

In modern polymer-electrolyte (PE) fuel cells, principally sulfonic acid-modified polymers are used (e.g. Nafion from DuPont). Owing to the water content-dependent conductivity mechanism of these membranes, fuel cells equipped with them can be operated only up to temperatures of from 80° C. to 100° C. At higher temperatures, this membrane dries out, so that the resistance of the membrane rises greatly and the fuel cell can no longer deliver any electrical energy.

In addition, polymer electrolyte membranes comprising complexes, for example, of basic polymers and strong acids have been developed. For instance, WO96/13872 and the corresponding U.S. Pat. No. 5,525,436 describe a process for producing a proton-conducting polymer electrolyte membrane, in which a basic polymer such as polybenzimidazole is treated with a strong acid such as phosphoric acid, sulfuric acid, etc.

J. Electrochem. Soc., volume 142, No. 7, 1995, p. L121-L123 describes the doping of a polybenzimidazole in phosphoric acid.

In the case of the basic polymer membranes known in the prior art, the mineral acid used to achieve the required proton conductivity (usually concentrated phosphoric acid) is added typically after the shaping of the polyazole film. The polymer serves as the carrier for the electrolyte consisting of the highly concentrated phosphoric acid. The polymer membrane fulfills further essential functions; in particular, it has to have a high mechanical stability and serve as a separator for the two fuels mentioned at the outset.

An essential advantage of such a phosphoric acid-doped membrane is the fact that a fuel cell in which such a polymer electrolyte membrane is used can be operated at temperatures above 100° C. without a moistening of the fuels which is otherwise necessary. The reason for this is the property of the phosphoric acid of being able to transport the protons without additional water by means of the so-called Grotthus mechanism (K.-D. Kreuer, Chem. Mater. 1996, 8, 610-641).

The possibility of operation at temperatures above 100° C. gives rise to further advantages for the fuel cell system. Firstly, the sensitivity of the Pt catalyst toward gas impurities, especially CO, is greatly reduced. CO is formed as a by-product in the reformation of the hydrogen-rich gas of carbon-containing compounds, for example natural gas, methanol or petroleum, or else as an intermediate in the direct oxidation of methanol. Typically, the CO content of the fuel at temperatures of <100° C. has to be less than 100 ppm. At temperatures in the 150-200° range, however, even 10 000 ppm of CO or more can be tolerated (N. J. Bjerrum et. al. Journal of Applied Electrochemistry, 2001, 31, 773-779). This leads to substantial simplifications of the upstream reforming process and thus to cost reductions of the entire fuel cell system.

The performance of a membrane-electrode unit produced with such membranes is described in WO 01/18894 A2. Determination is effected in a 5 cm² cell, at a gas flow rate of 160 ml/min and an elevated pressure of 1 atm for pure hydrogen, and at a gas flow rate of 200 ml/min and an elevated pressure of 1 atm for pure oxygen. However, the use of pure oxygen, such a high elevated pressure and such high stoichiometries is of no technical interest.

The performances with such phosphoric acid-doped polyazole membranes using pure hydrogen and pure oxygen are likewise described in Electrochimica Acta, volume 41, 1996, 193-197. With a platinum loading of 0.5 mg/cm² on the anode and 2 mg/cm² on the cathode, using moistened fuel gases, a current density of less than 0.2 A/cm² at a voltage of 0.6 V is achieved for each fuel gas with pure hydrogen and pure oxygen and an elevated pressure of 1 atm. When air is used instead of oxygen, this value falls to less than 0.1 A/cm².

A great advantage of fuel cells is the fact that, in the electrochemical reaction, the energy of the fuel is converted directly to electrical energy and heat. The reaction product formed at the cathode is water. The by-product formed in the electrochemical reaction is thus heat. For applications in which only the current is utilized to drive electric motors, for example for automobile applications, or as a versatile replacement of battery systems, some of the heat formed in the reaction has to be removed in order to prevent overheating of the system. For the cooling, additional energy-consuming units are necessary, which further reduce the overall electrical efficiency of the fuel cell system. For stationary applications, such as for the central or decentral generation of power and heat, the heat can be utilized efficiently by current technologies, for example heat exchangers. To increase the efficiency, high temperatures are desired. When the operating temperature is above 1000° C. and the temperature difference between the ambient temperature and the operating temperature is large, it becomes possible to cool the fuel cell system more efficiently or to use small cooling surfaces, and to dispense with additional units in comparison to fuel cells which have to be operated at below 100° C. owing to the membrane moistening.

However, such a fuel cell system also has disadvantages in addition to these advantages. For instance, the lifetime of phosphoric acid-doped membranes is relatively limited. The lifetime is lowered distinctly especially by operation of the fuel cell below 100° C., for example at 80° C. However, it should be emphasized in this context that the cell has to be operated at these temperatures when the fuel cell is started up and shut down.

In addition, the production of phosphoric acid-doped membranes is relatively expensive, since it is customary first to form a polymer which is subsequently cast to a film with the aid of a solvent. After the drying of the film, it is doped with an acid in a last step. Thus, the polymer membranes known to date have a high content of dimethylacetamide (DMAc) which cannot fully be removed by means of known drying methods.

Furthermore, the performance, for example the conductivity of known membranes, still needs to be improved.

Moreover, the mechanical stability of known high-temperature membranes with high conductivity still needs to be improved.

Moreover, a very large amount of catalytically active substances is used in order to obtain a membrane-electrode unit.

It is therefore an object of the present invention to provide a novel polymer electrolyte membrane which solves the problems laid out above. In particular, an inventive membrane shall be producible in an inexpensive and simple manner.

It was therefore a further object of the present invention to provide polymer electrolyte membranes which exhibit a high performance, especially a high conductivity over a wide temperature range. In this context, the conductivity, especially at high temperatures, shall be achieved without additional moistening. In this context, the membrane shall be suitable for further processing to a membrane-electrode unit which can:deliver particularly high power densities. In addition, a membrane-electrode unit obtainable by means of the inventive membrane shall have particularly high durability, especially a long lifetime at high power densities.

In addition, it is a further object of the present invention to provide a membrane which can be converted to a membrane-electrode unit which has a high performance even at a very low content of catalytically active substances, for example platinum, ruthenium or palladium.

It is a further object of the invention to provide a membrane which can be compressed to a membrane-electrode unit and the fuel cell can be operated at high power density with low stoichiometries, at low gas flow rate and/or at low elevated pressure.

In addition, it shall be possible to widen the operating temperature from <80° C. up to 200° C. without the lifetime of the fuel cell being lowered very greatly.

These objects are achieved by a proton-conducting polymer membrane which is coated with a catalyst layer and comprises polyazoles with all features of claim 1.

The present invention provides a proton-conducting polymer membrane coated with a catalyst layer, said polymer membrane comprising polymers which comprise phosphonic acid groups and are obtainable by polymerizing monomers comprising phosphonic acid groups, characterized in that the catalyst layer comprises ionomers which comprise phosphonic acid groups and are obtainable by polymerizing monomers comprising phosphonic acid groups.

An inventive membrane exhibits a high conductivity, which can be achieved even without additional moistening, over a wide temperature range.

In addition, an inventive membrane can be produced in a simple and inexpensive manner. For instance, it is possible in particular to dispense with large amounts of expensive solvents such as dimethylacetamide.

In addition, these membranes exhibit a surprisingly long lifetime. Moreover, a fuel cell which is equipped with an inventive membrane can be operated even at low temperatures, for example at 80° C., without the lifetime of the fuel cell being lowered very greatly as a result.

In addition, the membrane can be processed further to a membrane-electrode unit which can deliver particularly high currents. A membrane-electrode unit thus obtained has a particularly high durability, in particular a long lifetime at high currents.

In addition, the membrane of the present invention can be converted to a membrane-electrode unit which has a high performance even at a very low content of catalytically active substances, for example platinum, ruthenium or palladium.

The inventive polymer membrane has polymers which comprise phosphonic acid groups and are obtainable by polymerizing monomers comprising phosphonic acid groups.

Such polymer membranes are obtainable, inter alia, by a process comprising the steps of
A) preparing a composition comprising monomers comprising phosphonic acid groups,
B) applying a layer using the composition according to step A) on a support,
C) polymerizing the monomers comprising phosphonic acid groups present in the flat structure obtainable according to step B),
D) applying at least one catalyst layer to the membrane formed in step B) and/or in step C).

Monomers comprising phosphonic acid groups are known in the technical field. They are compounds which have at least one carbon-carbon double bond and at least one phosphonic acid group. The two carbon atoms which form the carbon-carbon double bond preferably have at least two, preferably 3, bonds to groups which lead to a low steric hindrance of the double bond. These groups include hydrogen atoms and halogen atoms, especially fluorine atoms. In the context of the present invention, the polymer comprising phosphonic acid groups arises from the polymerization product which is obtained by polymerization of the monomer comprising phosphonic acid groups alone or with further monomers and/or crosslinkers.

The monomer comprising phosphonic acid groups may comprise one, two, three or more carbon-carbon double bonds. In addition, the monomer comprising the phosphonic acid groups may comprise one, two, three or more phosphonic acid groups.

In general, the monomer comprising phosphonic acid groups comprises from 2 to 20, preferably from 2 to 10 carbon atoms.

The monomer which comprises phosphonic acid groups and is used in step A) is preferably a compound of the formula

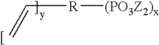

in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10
y is an integer of 1, 2, 3, 4, 5, 6, 7, 8, 9 or 10

and/or of the formula

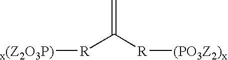

in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10

and/or of the formula

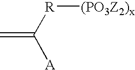

in which
A is a group of the formulae COOR², CN, CONR²₂, OR² and/or R², in which R² is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ₂,
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10.

The preferred monomers comprising phosphonic acid groups include alkenes which have phosphonic acid groups, such as ethenephosphonic acid, propenephosphonic acid, butenephosphonic acid; acrylic acid and/or methacrylic acid compounds which have phosphonic acid groups, for example 2-phosphonomethylacrylic acid, 2-phosphonomethyl-methacrylic acid, 2-phosphonomethylacrylamide and 2-phosphonomethylmethacrylamide.

Particular preference is given to commercial vinylphosphonic acid (ethenephosphonic acid), as obtainable, for example, from Aldrich or Clariant GmbH. A preferred vinylphosphonic acid has a purity of more than 70%, in particular 90% and more preferably 97% purity.

The monomers comprising phosphonic acid groups may additionally also be used in the form of derivatives which may subsequently be converted to the acid, in which case the conversion to the acid can also be effected in the polymerized state. These derivatives include in particular the salts, the esters, the amides and the halides of the monomers comprising phosphonic acid groups.

The composition prepared in step A) may additionally comprise preferably at least 20% by weight, in particular at least 30% by weight and more preferably at least 50% by weight, based on the total weight of the composition, of monomers comprising phosphonic acid groups.

The composition prepared in step A) may additionally also comprise further organic and/or inorganic solvents. The organic solvents include in particular polar aprotic solvents such as dimethyl sulfoxide (DMSO), esters such as ethyl acetate, and polar protic solvents such as alcohols such as ethanol, propanol, isopropanol and/or butanol. The inorganic solvents include in particular water, phosphoric acid and polyphosphoric acid.

These can positively influence the processability. In particular, addition of the organic solvent improves the solubility of polymers which are formed, for example, in step B). The content of monomers comprising phosphonic acid groups in such solutions is generally at least 5% by weight, preferably at least 10% by weight, more preferably between 10 and 97% by weight.

In a particular aspect of the present invention, the polymers comprising phosphonic acid groups and/or ionomers comprising phosphonic acid groups can be prepared by using compositions which comprise monomers comprising sulfonic acid groups.

Monomers comprising sulfonic acid groups are known in the technical field. They are compounds which have at least one carbon-carbon double bond and at least one sulfonic acid group. The two carbon atoms which form the carbon-carbon double bond preferably have at least two, preferably 3 bonds to groups which lead to low steric hindrance of the double bond. These groups include hydrogen atoms and halogen atoms, especially fluorine atoms. In the context of the present invention, the polymer comprising sulfonic acid groups arises from the polymerization product which is obtained by polymerization of the monomer comprising sulfonic acid groups alone or with further monomers and/or crosslinkers.

The monomer comprising sulfonic acid groups may comprise one, two, three or more carbon-carbon double bonds. Moreover, the monomer comprising sulfonic acid groups may comprise one, two, three or more sulfonic acid groups.

In general, the monomer comprising sulfonic acid groups comprises from 2 to 20, preferably from 2 to 10 carbon atoms.

The monomer comprising sulfonic acid groups comprises preferably compounds of the formula

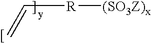

in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10
y is an integer of 1, 2, 3, 4, 5, 6, 7, 8, 9 or 10

and/or of the formula

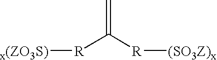

in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10

and/or of the formula

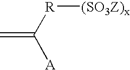

in which
A is a group of the formulae COOR², CN, CONR²₂, OR² and/or R², in which R² is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ₂
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10.

The preferred monomers comprising sulfonic acid groups include alkenes which have sulfonic acid groups, such as ethenesulfonic acid, propenesulfonic acid, butenesulfonic acid; acrylic acid and/or methacrylic acid compounds which have sulfonic acid groups, for example 2-sulfonomethylacrylic acid, 2-sulfonomethylmethacrylic acid, 2-sulfonomethylacrylamide and 2-sulfonomethylmethacrylamide.

Particular preference is given to using commercial vinylsulfonic acid (ethenesulfonic acid), as obtainable, for example, from Aldrich or Clariant GmbH. A preferred vinylsulfonic acid has a purity of more than 70%, in particular 90% and more preferably more than 97% purity.

The monomers comprising sulfonic acid groups may additionally also be used in the form of derivatives which can subsequently be converted to the acid, in which case the conversion to the acid can also be effected in the polymerized state. These derivatives include in particular the acids, the esters, the amides and the halides of the monomers comprising sulfonic acid groups.

In a particular aspect of the present invention, the weight ratio of monomers comprising sulfonic acid groups to monomers comprising phosphonic acid groups may be in the range from 100:1 to 1:100, preferably from 10:1 to 1:10 and more preferably from 2:1 to 1:2.

In a further embodiment of the invention, monomers capable of crosslinking may be used in the production of the polymer membrane. These monomers may be added to the composition according to step A). Moreover, the monomers capable of crosslinking may also be applied to the flat structure according to step C).

The monomers capable of crosslinking are in particular compounds which have at least 2 carbon-carbon double bonds. Preference is give to dienes, trienes, tetraenes, dimethyl-acrylates, trimethylacrylates, tetramethylacrylates, diacrylates, triacrylates, tetraacrylates.

Particular preference is given to dienes, trienes, tetraenes of the formula

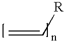

dimethylacrylates, trimethylacrylates, tetramethylacrylates of the formula

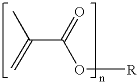

diacrylates, triacrylates, tetraacrylates of the formula

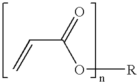

in which
R is a C1-C15-alkyl group, C5-C20-aryl or-heteroaryl group, NR′, —SO₂, PR′, Si(R′)₂, where the above radicals may themselves be substituted,
R′ are each independently hydrogen, a C1-C15-alkyl group, C1-C15-alkoxy group, C5-C20-aryl or -heteroaryl group and
n is at least 2.

The constituents of the aforementioned R radical are preferably halogen, hydroxyl, carboxy, carboxyl, carboxyl ester, nitriles, amines, silyl, siloxane radicals.

Particularly preferred crosslinkers are allyl methacrylate, ethylene glycol dimethacrylate, diethylene glycol dimethacrylate, triethylene glycol dimethacrylate, tetra- and polyethylene glycol dimethacrylate, 1,3-butanediol dimethacrylate, glycerol dimethacrylate, diurethane dimethacrylate, trimethylpropane trimethacrylate, epoxyacrylates, for example Ebacryl, N′,N-methylenebisacrylamide, carbinol, butadiene, isoprene, chloroprene, divinylbenzene and/or bisphenol A dimethylacrylate. These compounds are commercially available, for example, from Sartomer Company Exton, Pennsylvania under the designations CN-120, CN104 and CN-980.

The use of crosslinkers is optional, these compounds being usable typically in the range between 0.05 to 30% by weight, preferably from 0.1 to 20% by weight, more preferably 1 and 10% by weight, based on the weight of the monomers comprising phosphonic acid groups.

The polymer membranes of the present invention may, in addition to the polymers comprising phosphonic acid groups, comprise further polymers (B) which are not obtainable by polymerizing monomers comprising phosphonic acid groups.

For this purpose, for example, a further polymer (B) may be added to the composition obtained in step A). This polymer (B) may, inter alia, be present in dissolved, dispersed or suspended form.

Preferred polymers (B) include polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyvinyl difluoride, polyhexafluoro-propylene, polyethylene-tetrafluoroethylene, copolymers of PTFE with hexafluoropropylene, with perfluoropropyl vinyl ether, with trifluoronitrosomethane, with carbalkoxyperfluoroalkoxy-vinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular those of norbornene;

polymers having C—O bonds in the backbone, for example polyacetal, polyoxymethylene, polyethers, polypropylene oxide, polyepichlorohydrin, polytetrahydrofuran, polyphenylene oxide, polyether ketone, polyether ether ketone, polyether ketone ketone, polyether ether ether ketone ketone, polyether ketone ether ketone ketone, polyesters, in particular polyhydroxyacetic acid, polyethylene terephthalate, polybutylene terephthalate, polyhydroxybenzoate, polyhydroxypropionic acid, polypropionic acid, polypivalolactone, polycaprolactone, furan resins, phenol-aryl resins, polymalonic acid, polycarbonate; polymers having C—S bonds in the backbone, for example polysulfide ethers, polyphenylene sulfide, polyether sulfone, polysulfone, polyether ether sulfone, polyaryl ether sulfone, polyphenylenesulfone, polyphenylene sulfide sulfone, poly(phenyl sulfide-1,4-phenylene); polymers having C—N bonds in the backbone, for example polyimines, polyisocyanides, polyetherimine, polyetherimides, poly(trifluoromethylbis(phthalimide)phenyl), polyaniline, polyaramids, polyamides, polyhydrazides, polyurethanes, polyimides, polyazoles, polyazole ether ketone, polyureas, polyazines;

liquid-crystalline polymers, in particular Vectra, and

inorganic polymers, for example polysilanes, polycarbosilanes, polysiloxanes, polysilicic acid, polysilicates, silicones, polyphosphazenes and polythiazyl.

These polymers may be used individually or as a mixture of two, three or more polymers.

Particular preference is given to polymers which contain at least one nitrogen atom, oxygen atom and/or sulfur atom in a repeat unit. Especially preferred are polymers which contain at least one aromatic ring having at least one nitrogen, oxygen and/or sulfur heteroatom per repeat unit. Within this group, preference is given in particular to polymers based on polyazoles. These basic polyazole polymers contain at least one aromatic ring with at least one nitrogen heteroatom per repeat unit.

The aromatic ring is preferably a five- or six-membered ring having from one to three nitrogen atoms which may be fused with another ring, in particular another aromatic ring.

Polymers based on polyazole generally contain repeat azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVI) and/or (XVII) and/or (XVIII) and/or (XIX) and/or (XX) and/or (XXI) and/or (XXII)

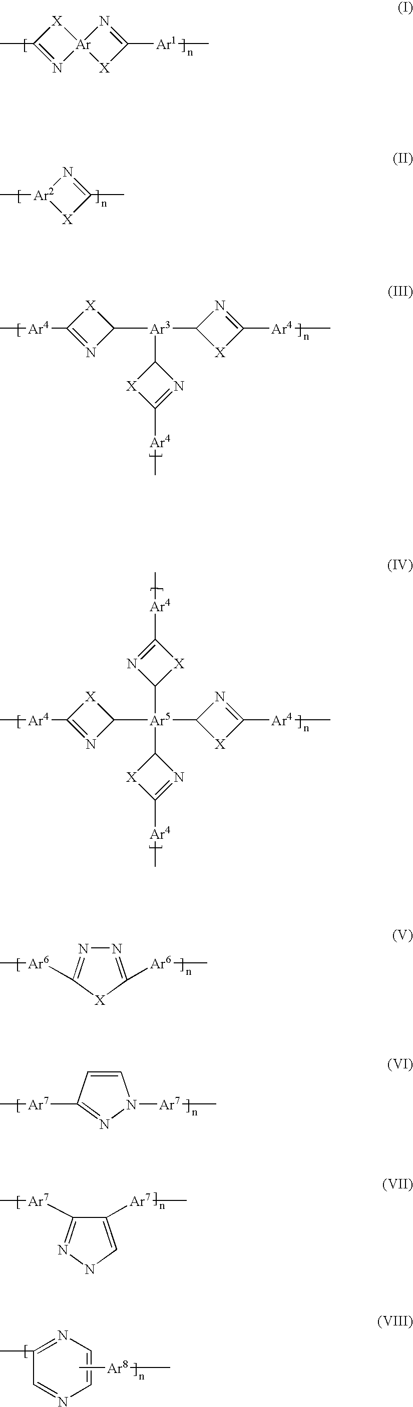

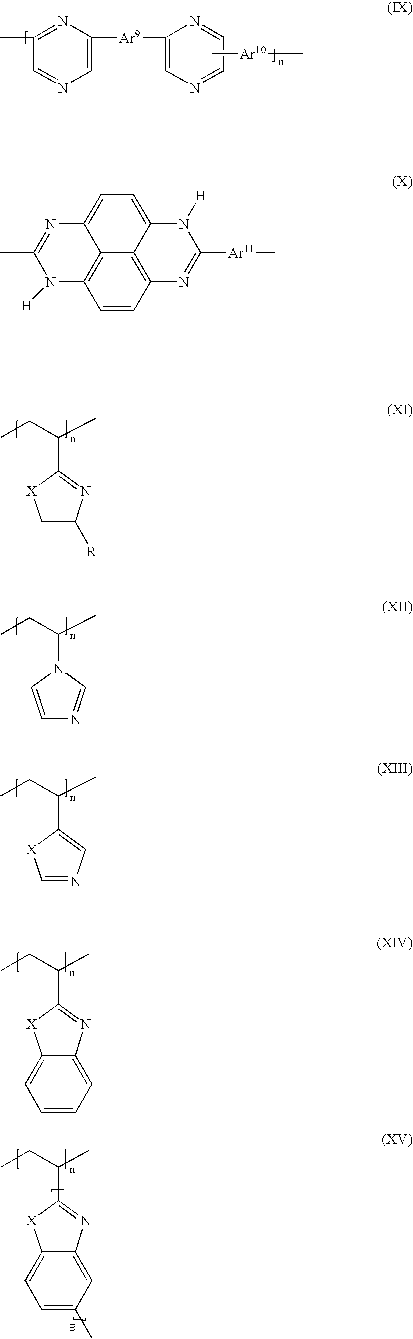

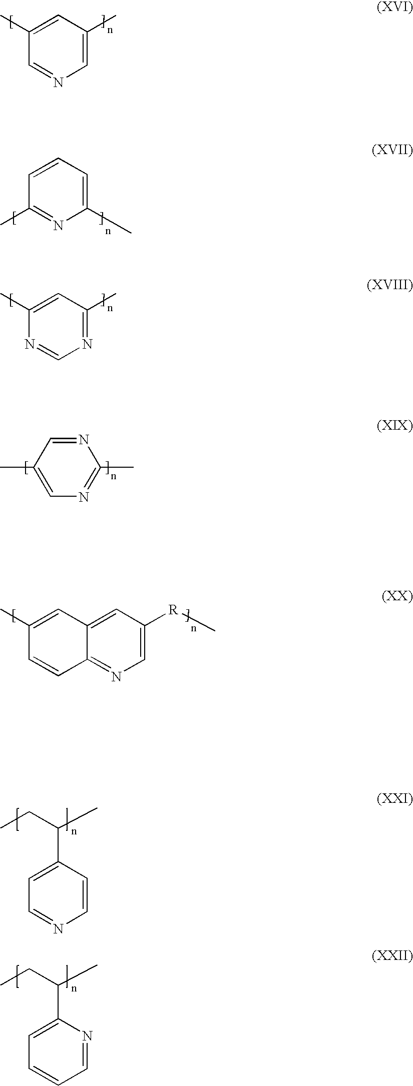

in which
Ar are the same or different and are each a tetravalent aromatic or heteroaromatic group which may be mono- or polycyclic,
Ar¹ are the same or different and are each a divalent aromatic or heteroaromatic group which may be mono- or polycyclic,
Ar² are the same or different and are each a di- or trivalent aromatic or heteroaromatic group which may be mono- or polycyclic,
Ar³ are the same or different and are each a trivalent aromatic or heteroaromatic group which may be mono- or polycyclic,
Ar⁴ are the same or different and are each a trivalent aromatic or heteroaromatic group which may be mono- or polycyclic,
Ar⁵ are the same or different and are each a tetravalent aromatic or heteroaromatic group which may be mono- or polycyclic,
Ar⁶ are the same or different and are each a divalent aromatic or heteroaromatic group which may be mono- or polycyclic,
Ar⁷ are the same or different and are each a divalent aromatic or heteroaromatic group which may be mono- or polycyclic,
Ar⁸ are the same or different and are each a trivalent aromatic or heteroaromatic group which may be mono- or polycyclic,
Ar⁹ are the same or different and are each a di- or tri- or tetravalent aromatic or heteroaromatic group which may be mono- or polycyclic,
Ar¹⁰ are the same or different and are each a di- or trivalent aromatic or heteroaromatic group which may be mono- or polycyclic,
Ar¹¹ are the same or different and are each a divalent aromatic or heteroaromatic group which may be mono- or polycyclic,
X are the same or different and are each oxygen, sulfur or an amino group which bears a hydrogen atom, a group having 1-20 carbon atoms, preferably a branched or unbranched alkyl or alkoxy group, or an aryl group as further radical,
R is the same or different and is hydrogen, an alkyl group and an aromatic group is the same or different and is hydrogen, an alkyl group and an aromatic group, with the proviso that R in formula XX is a divalent group, and
n, m are each an integer greater than or equal to 10, preferably greater than or equal to 100.

Preferred aromatic or heteroaromatic groups derived from benzene, naphthalene, biphenyl, diphenyl ether, diphenylmethane, diphenyidimethylmethane, bisphenone, diphenyl sulfone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]-thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, acridine, phenazine, benzoquinoline, phenoxazine, phenothiazine, acridizine, benzopteridine, phenanthroline and phenanthrene, which may optionally also be substituted.

The substitution pattern of Ar¹, Ar⁴, Ar⁶, Ar⁷, Ar⁸, Ar⁹, Ar¹⁰, Ar¹¹ is as desired; in the case of phenylene, for example, Ar¹, Ar⁴, Ar⁶, Ar⁷, Ar⁸, Ar⁹, Ar¹⁰, Ar¹¹ may be ortho-, meta- and para-phenylene. Particularly preferred groups derive from benzene and biphenylene, which may optionally also be substituted.

Preferred alkyl groups are short-chain alkyl groups having from 1 to 4 carbon atoms, for example methyl, ethyl, n- or i-propyl and t-butyl groups.

Preferred aromatic groups are phenyl or naphthyl groups. The alkyl groups and the aromatic groups may be substituted.

Preferred substituents are halogen atoms, for example fluorine, amino groups, hydroxy groups or short-chain alkyl groups, for example methyl or ethyl groups.

Preference is given to polyazoles having repeat units of the formula (I) in which the X radicals are the same within one repeat unit.

The polyazoles may in principle also have different repeat units which differ, for example, in their X radical. However, it preferably has only identical X radicals in a repeat unit.

Further preferred polyazole polymers are polyimidazoles, polybenzothiazoles, polybenzooxazoles, polyoxadiazoles, polyquinoxalines, polythiadiazoles, poly(pyridines), poly(pyrimidines) and poly(tetraazapyrenes).

In a further embodiment of the present invention, the polymer containing repeat azole units is a copolymer or a blend which contains at least two units of the formula (I) to (XXII) which differ from one another. The polymers may be in the form of block copolymers (diblock, triblock), random copolymers, periodic copolymers and/or alternating polymers.

In a particularly preferred embodiment of the present invention, the polymer containing repeat azole units is a polyazole which contains only units of the formula (I) and/or (II).

The number of repeat azole units in the polymer is preferably an integer greater than or equal to 10. Particularly preferred polymers contain at least 100 repeat azole units.

In the context of the present invention, preference is given to polymers containing repeat benzimidazole units. Some examples of the highly appropriate polymers containing repeat benzimidazole units are represented by the following formulae:

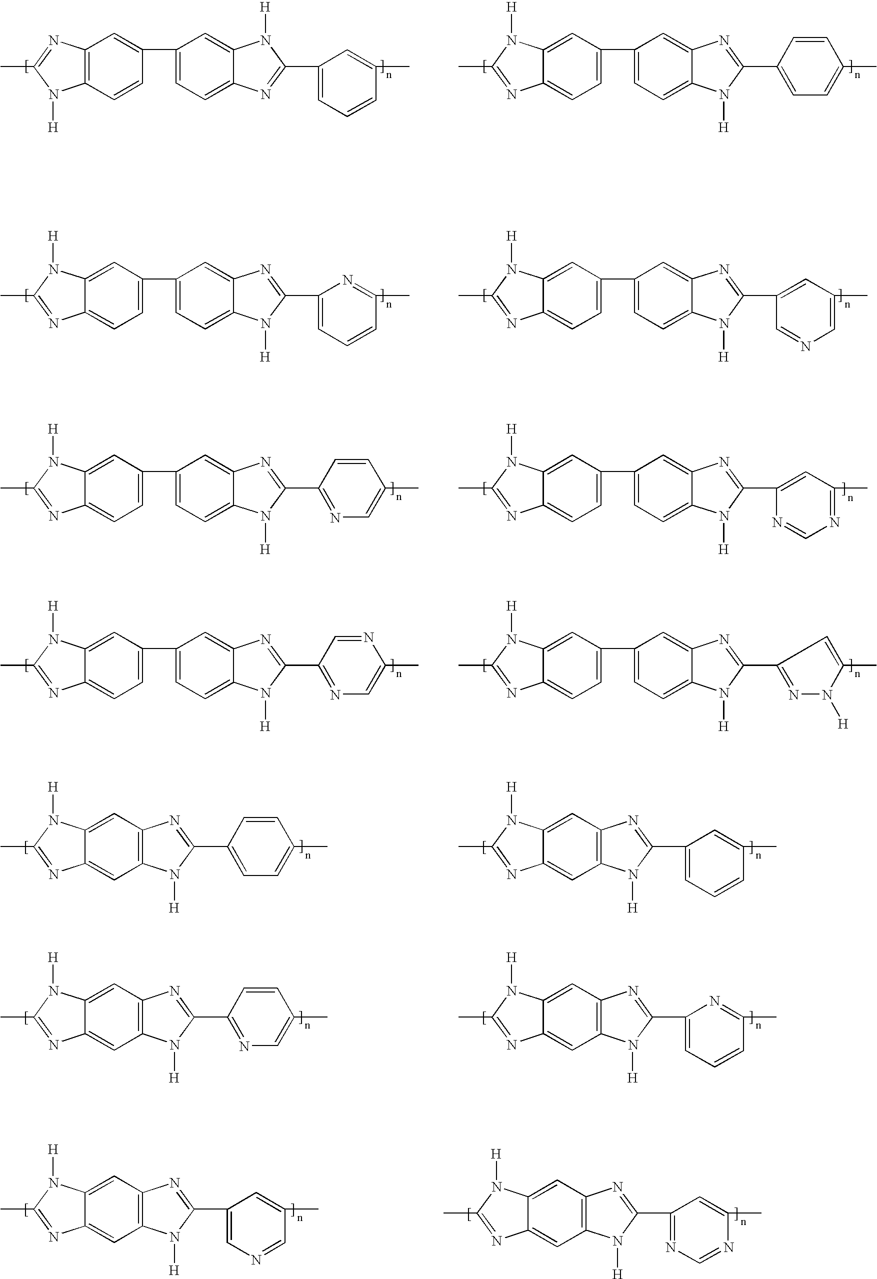

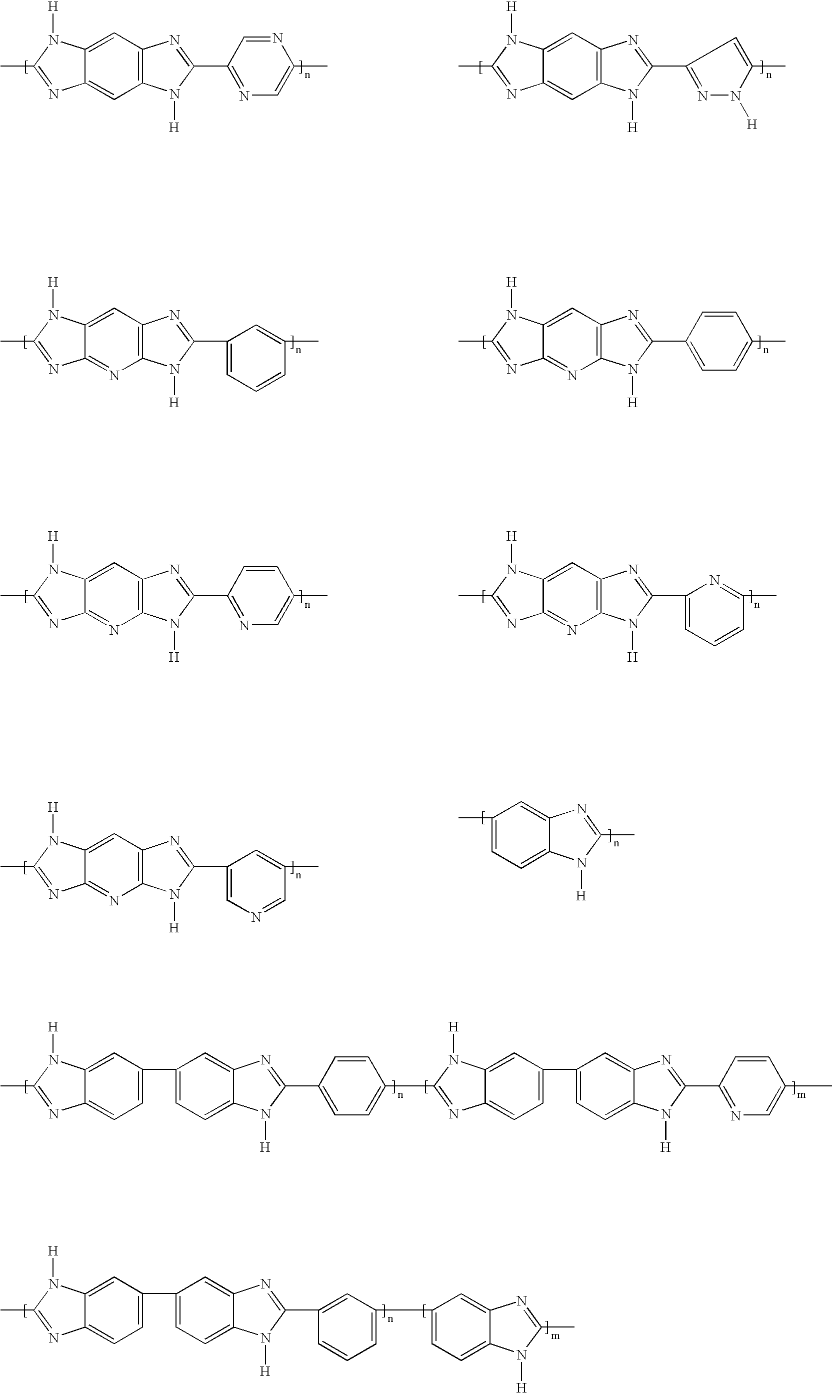

where n and m are each an integer greater than or equal to 10, preferably greater than or equal to 100.

Further preferred polyazole polymers are polyimidazoles, polybenzimidazole ether ketone, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Preferred polyazoles feature a high molecular weight. This is especially true of the polybenzimidazoles. Measured as the intrinsic viscosity, this is preferably at least 0.2 dl/g, preferably from 0.7 to 10 dl/g, in particular from 0.8 to 5 dl/g.

Particular preference is given to Celazole from Celanese. The properties of the polymer film and polymer membrane may be improved by sieving the starting polymer, as described in the German patent application No. 10129458.1.

In addition, the polymer (B) used may be polymer with aromatic sulfonic acid groups. Aromatic sulfonic acid groups are groups in which the sulfonic acid group (—SO₃H) is bonded covalently to an aromatic or heteroaromatic group. The aromatic group may be part of the backbone of the polymer or part of a side group, preference being given to polymers having aromatic groups in the backbone. The sulfonic acid groups may in many cases also be used in the form of the salts. In addition, it is also possible to use derivatives, for example esters, especially methyl or ethyl esters, or halides of the sulfonic acids, which are converted to the sulfonic acid in the course of operation of the membrane.

The polymers modified with sulfonic acid groups preferably have a content of sulfonic acid groups in the range from 0.5 to 3 meq/g, preferably from 0.5 to 2.5 meq/g. This value is determined via the so-called ion exchange capacity (IEC).

To measure the IEC, the sulfonic acid groups are converted to the free acid. To this end, the polymer is treated with acid in a known manner, excess acid being removed by washing. Thus, the sulfonated polymer is treated first in boiling water for 2 hours. Subsequently, excess water is dabbed off and the sample is dried at p <1 mbar in a vacuum drying cabinet at 160° C. over 15 hours. The dry weight of the membrane is then determined. The polymer thus dried is then dissolved in DMSO at 80° C. over 1 h. The solution is subsequently titrated with 0.1 M NaOH. From the consumption of the acid up to the equivalence point and the dry weight, the ion exchange capacity (IEC) is then calculated.

Polymers having sulfonic acid groups bonded covalently to aromatic groups are known in the technical field. For example, polymer having aromatic sulfonic acid groups can be prepared by sulfonating polymers. Processes for sulfonating polymers are described in F. Kucera et. al. Polymer Engineering and Science 1988, Vol. 38, No 5, 783-792. In this process, the sulfonation conditions can be selected so as to result in a low degree of sulfonation (DE-A-19959289).

With regard to polymers having aromatic sulfonic acid groups whose aromatic radicals are part of the side groups, reference is made in particular to polystyrene derivatives. For instance, the publication U.S. Pat. No. 6,110,616 describes copolymers of butadiene and styrene and their subsequent sulfonation for use for fuel cells.

In addition, such polymers may also be obtained by poly reactions of monomers which comprise acid groups. For instance, perfluorinated polymers can, as described in U.S. Pat. No. 5,422,411, be prepared by copolymerization of trifluorostyrene and sulfonyl-modified trifluorostyrene.

In a particular aspect of the present invention, high-temperature-stable thermoplastics which have sulfonic acid groups bonded to aromatic groups are used. In general, such polymers have aromatic groups in the main chain. Preference is thus given to sulfonated polyether ketones (DE-A-4219077, WO96/01177), sulfonated polysulfones (J. Membr. Sci. 83 (1993) p. 211) or sulfonated polyphenylene sulfide (DE-A-19527435).

The polymers which have sulfonic acid groups bonded to aromatics and have been detailed above may be used individually, or as a mixture, in which case preference is given in particular to mixtures which have polymers with aromatics in the backbone.

The preferred polymers include polysulfones, especially polysulfone having aromatics in the backbone. In a particular aspect of the present invention, preferred polysulfones and polyether sulfones have a melt volume flow rate MVR 300/21.6 less than or equal to 40 cm³/10 min, in particular less than or equal to 30 cm³/10 min and more preferably less than or equal to 20 cm³/10 min, measured to ISO 1133.

In a particular aspect of the present invention, the weight ratio of polymer having sulfonic acid groups bonded covalently to aromatic groups to monomers comprising phosphonic acid groups may be in the range from 0.1 to 50, preferably from 0.2 to 20, more preferably from 1 to 10.

In a particular aspect of the present invention, preferred proton-conducting polymer membranes are obtainable by a process comprising the steps of
I) swelling a polymer film with a liquid which comprises monomers comprising phosphonic acid groups,
II) polymerizing at least some of the monomers comprising phosphonic acid groups which have been introduced into the polymer film in step I) and
III) applying at least one catalyst layer to the membrane formed in step II).

Swelling is understood to mean an increase in the weight of the film of at least 3% by weight. The swelling is at least 5%, more preferably at least 10%.

Determination of the swelling Q is determined gravimetrically from the mass of the film before swelling mₒ and the mass of the film after the polymerization in step B), m₂.
Q=(m₂−m₀)/m₀×100

The swelling is effected preferably at a temperature above 0° C., in particular between room temperature (20° C.) and 180° C., in a liquid which preferably comprises at least 5% by weight of monomers comprising phosphonic acid groups. In addition, the swelling can also be carried out at elevated pressure. In this context, the limits arise from economic considerations and technical means.

The polymer film used for swelling generally has a thickness in the range from 5 to 3000 μm, preferably from 10 to 1500 μm and more preferably from 20 to 500 μm. The production of such films from polymers is common knowledge, and some of them are commercially available.

The liquid which comprises monomers comprising phosphonic acid groups may be a solution, in which case the liquid may also comprise suspended and/or dispersed constituents. The viscosity of the liquid which comprises monomers comprising phosphonic acid groups can lie within wide ranges, and solvents can be added or the temperature can be increased to adjust the viscosity. The dynamic viscosity is preferably in the range from 0.1 to 10 000 mPa*s, in particular from 0.2 to 2000 mPa*s, and these values may be measured, for example, according to DIN 53015.

The mixture prepared in step A) or the liquid used in step I) may additionally also comprise further organic and/or inorganic solvents. The organic solvents include in particular polar aprotic solvents such as dimethyl sulfoxide (DMSO), esters, such as ethyl acetate, and polar protic solvents such as alcohols, such as ethanol, propanol, isopropanol and/or butanol. The inorganic solvents include in particular water, phosphoric acid and polyphosphoric acid. These can positively influence the processability. For example, the rheology of the solution can be improved, so that it can be extruded or knife-coated more readily.

To further improve the performance properties, it is possible additionally to add to the membrane fillers, especially proton-conducting fillers, and also additional acids. Such substances preferably have an intrinsic conductivity at 100° C. of at least 10⁻⁶ S/cm, in particular 10⁻⁵ S/cm. The addition can be effected, for example, in step A) and/or step B) or step I). In addition, these additives, if they are present in liquid form, may also be added after the polymerization in step C) or step II).

Nonlimiting examples of proton-conducting fillers are

| | |
|---|---|
| sulfates such as: | CsHSO₄, Fe(SO₄)₂, (NH₄)₃H(SO₄)₂, LiHSO₄, NaHSO₄, KHSO₄, |
| | RbSO₄, LiN₂H₅SO₄, NH₄HSO₄, |
| phosphates such as | Zr₃(PO₄)₄, Zr(HPO₄)₂, HZr₂(PO₄)₃, UO₂PO₄•3H₂O, H₈UO₂PO₄, |
| | Ce(HPO₄)₂, Ti(HPO₄)₂, KH₂PO₄, NaH₂PO₄, LiH₂PO₄, NH₄H₂PO₄, |
| | CsH₂PO₄, CaHPO₄, MgHPO₄, HSbP₂O₈, HSb₃P₂O₁₄, |
| | H₅Sb₅P₂O₂₀, |
| polyacids such as | H₃PW₁₂O₄₀•nH₂O (n = 21-29), H₃SiW₁₂O₄₀•nH₂O (n = 21-29), |
| | HₓWO₃, HSbWO₆, H₃PMo₁₂O₄₀, H₂Sb₄O₁₁, HTaWO₆, HNbO₃, |
| | HTiNbO₅, HTiTaO₅, HSbTeO₆, H₅Ti₄O₉, HSbO₃, H₂MoO₄ |
| selenites and arsenides such as | (NH₄)₃H(SeO₄)₂, UO₂AsO₄, (NH₄)₃H(SeO₄)₂, KH₂AsO₄, |
| | Cs₃H(SeO₄)₂, Rb₃H(SeO₄)₂, |
| phosphides such as | ZrP, TiP, HfP |
| oxides such as | Al₂O₃, Sb₂O₅, ThO₂, SnO₂, ZrO₂, MoO₃ |
| silicates such as | zeolites, zeolites(NH₄+), sheet silicates, framework silicates, |
| | H-natrolites, H-mordenites, NH₄-analcines, NH₄-sodalites, NH₄- |
| | gallates, H-montmorillonites |
| acids such as | HClO₄, SbF₅ |
| fillers such as | carbides, in particular SiC, Si₃N₄, fibers, in particular glass |
| | fibers, glass powders and/or polymer fibers, preferably ones |
| | based on polyazoles. |

These additives may be present in customary amounts in the proton-conducting polymer membrane, although the positive properties, such as high conductivity, long lifetime and high mechanical stability of the membrane, should not be impaired all too greatly by addition of excessively large amounts of additives. In general, the membrane after the polymerization in step C) or step II) comprises not more than 80% by weight, preferably not more than 50% by weight and more preferably not more than 20% by weight of additives.

In addition, this membrane may further comprise perfluorinated sulfonic acid additives (preferably 0.1-20% by weight, more preferably 0.2-15% by weight, very particularly preferably 0.2-10% by weight). These additives lead to an increase in power, to an increase in the oxygen solubility and oxygen diffusion in the vicinity of the cathode and to a reduction in the adsorption of electolytes on the the catalyst surface. (Electrolyte additives for phosphoric acid fuel cells. Gang, Xiao; Hjuler, H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902 and Perfluorosulfonimide as an additive in phosphoric acid fuel cell. Razaq, M.; Razaq, A.; Yeager, E.; DesMarteau, Darryl, D.; Singh, S. Case Cent. Electrochem. Sci., Case West, Reserve Univ., Cleveland, Ohio, USA. J. Electrochem. Soc. (1989), 136(2), 385-90.)

Nonlimiting examples of persulfonated additives are:

trifluoromethanesulfonic acid, potassium trifluoromethanesulfonate, sodium trifluoro-methanesulfonate, lithium trifluoromethanesulfonate, ammonium trifluoromethanesulfonate, potassium perfluorohexanesulfonate, sodium perfluorohexanesulfonate, lithium perfluoro-hexanesulfonate, ammonium perfluorohexanesulfonate, perfluorohexanesulfonic acid, potassium nonafluorobutanesulfonate, sodium nonafluorobutanesulfonate, lithium nonafluorobutanesulfonate, ammonium nonafluorobutanesulfonate, cesium nonafluoro-butanesulfonate, triethylammonium perfluorohexanesulfonate and perfluorosulfonimides.

The formation of the flat structure in step B) is effected by means of measures known per se from the prior art for polymer film production (casting, spraying, knife-coating, extrusion). Suitable supports are all supports which can be designated inert under the conditions. These supports include, in particular, films of polyethylene terephthalate (PET), polytetrafluoroethylene (PTFE), polyhexafluoropropylene, copolymers of PTFE with hexafluoropropylene, polyimides, polyphenylene sulfides (PPS) and polypropylene (PP).

The thickness of the flat structure obtained in step B) is preferably between 10 and 4000 μm, preferably between 15 and 3500 μm, in particular between 20 and 3000 μm, more preferably between 30 and 1500 μm and most preferably between 50 and 500 μm.

The polymerization of the monomers comprising phosphonic acid groups in step C) or step II) is preferably effected by free-radical means. Free-radical formation can be effected thermally, photochemically, chemically and/or electrochemically.

For example, an initiator solution which comprises at least one substance capable of forming free radicals can be added to the composition after the composition has been heated in step A). In addition, an initiator solution can be applied to the flat structure obtained after step B). This can be done by methods known per se from the prior art (for example spraying, dipping, etc.). When the membranes are prepared by swelling, an initiator solution can be added to the liquid. This can also be applied to the flat structure after the swelling.

Suitable free-radical formers include azo compounds, peroxy compounds, persulfate compounds or azoamidines. Nonlimiting examples are dibenzoyl peroxide, dicumene peroxide, cumene hydroperoxide, diisopropyl peroxydicarbonate, bis(4-t-butylcyclohexyl)peroxydicarbonate, dipotassium persulfate, ammonium peroxodisulfate, 2,2′-azobis(2-methylpropionitrile) (AIBN), 2,2′-azobis(isobutyroamidine)hydrochloride, benzopinacol, dibenzyl derivatives, methylethylene ketone peroxide, 1,1-azobiscyclohexanecarbonitrile, methyl ethyl ketone peroxide, acetylacetone peroxide, dilauryl peroxide, didecanoyl peroxide, tert-butyl per-2-ethylhexanoate, ketone peroxide, methyl isobutyl ketone peroxide, cyclo-hexanone peroxide, dibenzoyl peroxide, tert-butyl peroxybenzoate, tert-butyl peroxyiso-propylcarbonate, 2,5-bis(2-ethylhexanoylperoxy)-2,5-dimethylhexane, tert-butyl peroxy-2-ethyihexanoate, tert-butyl peroxy-3,5,5-trimethylhexanoate, tert-butyl peroxyisobutyrate, tert-butyl peroxyacetate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl)peroxydicarbonate and also the free-radical formers obtainable from DuPont under the name ®Vazo, for example ®Vazo V50 and ®Vazo WS.

In addition, it is also possible to use free-radical formers which form free radicals upon irradiation. Preferred compounds include α,α-diethoxyaceto-phenone (DEAP, Upjohn Corp), n-butylbenzoin ether (®Trigonal-14, AKZO) and 2,2-dimethoxy-2-phenylacetophenone (®Irgacure 651) and 1-benzoyl-cyclohexanol (®Irgacure 184), bis(2,4,6-trimethylbenzoyl)-phenylphosphine oxide (®Irgacure 819) and 1-[4-(2-hydroxyethoxy)phenyl]-2-hydroxy-2-phenylpropan-1-one (®Irgacure 2959), each of which are commercially available from Ciba Geigy Corp.

Typically between 0.0001 and 5% by weight, in particular between 0.01 and 3% by weight (based on the weight of the monomers comprising phosphonic acid groups) of free-radical formers are added. The amount of free-radical formers can be varied depending on the desired degree of polymerization.

The polymerization can also be effected by action of IR or NIR (IR=infrared, i.e. light having a wavelength of more than 700 nm; NIR=near IR, i.e. light having a wavelength in the range from about 700 to 2000 nm or an energy in the range from about 0.6 to 1.75 eV).

The polymerization can also be effected by action of UV light having a wavelength of less than 400 nm. This polymerization method is known per se and is described, for example, in Hans Joerg Elias, Makromolekulare Chemie [Macromolecular Chemistry], 5th edition, volume 1, pp. 492-511; D. R. Arnold, N. C. Baird, J. R. Bolton, J. C. D. Brand, P. W. M. Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerization can also be achieved by the action of β-rays, γ-rays and/or electron beams. In a particular embodiment of the present invention, a membrane is irradiated with a radiation dose in the range from 1 to 300 kGy, preferably from 3 to 250 kGy and most preferably from 20 to 200 kGy.

The polymerization of the monomers comprising phosphonic acid groups in step C is effected preferably at temperatures above room temperature (20° C.) and less than 200° C., in particular at temperatures between 40° C. and 150° C., more preferably between 50° C. and 120° C. The polymerization is effected preferably under atmospheric pressure, but can also be effected under the action of pressure. The polymerization leads to a strengthening of the flat structure, and this strengthening can be monitored by microhardness measurement. The increase in hardness resulting from the polymerization is preferably at least 20%, based on the hardness of the flat structure obtained in step B).

In a particular embodiment of the present invention, the membranes have a high mechanical stability. This parameter arises from the hardness of the membranes, which is determined by means of microhardness measurements to DIN 50539. For this purpose, the membrane is loaded with a Vickers diamond gradually up to a force of 3 mN within 20 s and the penetration depth is determined. According to this, the hardness at room temperature is at least 0.01 N/mm², preferably at least 0.1 N/mm² and most preferably at least 1 N/mm², without any intention that this should impose a restriction. Subsequently, the force is kept constant at 3 mN over 5 s and the creep from the penetration depth is calculated. In the case of preferred membranes, the creep C_{HU} 0.003/20/5 under these conditions is less than 20%, preferably less than 10% and most preferably less than 5%. The modulus YHU determined by means of microhardness measurement is at least 0.5 MPa, in particular at least 5 MPa and most preferably at least 10 MPa, without any intention that this should impose a restriction.

The membrane hardness relates both to a surface which has no catalyst layer and to a side which has a catalyst layer.

Depending on the desired degree of polymerization, the flat structure which is obtained by the polymerization is a self-supporting membrane. The degree of polymerization is preferably at least 2, in particular at least 5, more preferably at least 30 repeat units, in particular at least 50 repeat units, most preferably at least 100 repeat units. This degree of polymerization is determined via the number-average molecular weight Mₙ, which can be determined by GPC methods. Owing to the problems of isolating the polymers comprising phosphonic acid groups present in the membrane without degradation, this value is determined with the aid of a sample which is carried out by polymerization of monomers comprising phosphonic acid groups without addition of polymer. In this case, the proportion by weight of monomers comprising phosphonic acid groups and of free-radical initiator is kept constant in comparison to the conditions of the production of the membrane. The conversion which is achieved in a comparative polymerization is preferably greater than or equal to 20%, in particular greater than or equal to 40% and more preferably greater than or equal to 75%, based on the monomers comprising phosphonic acid groups used.

The polymers comprising phosphonic acid groups present in the membrane preferably have a broad molecular weight distribution. Thus, the polymers comprising phosphonic acid groups may have a polydispersity M_{w}/Mₙ in the range from 1 to 20, more preferably from 3 to 10.

The water content of the proton-conducting membrane is preferably at most 15% by weight, moret preferably at most 10% by weight and most preferably at most 5% by weight.

In this connection, it can be assumed that the conductivity of the membrane may be based on the Grotthus mechanism, as a result of which the system does not require any additional moistening. Accordingly, preferred membranes comprise fractions of low molecular weight polymers comprising phosphonicacid groups. Thus, the fraction of polymers which comprise phosphonic acid groups and have a degree of polymerization in the range from 2 to 20 may preferably be at least 10% by weight, more preferably at least 20% by weight, based on the weight of the polymers comprising phosphonic acid groups.

The polymerization in step C) or step II) may lead to a decrease in the layer thickness. The thickness of the self-supporting membrane is preferably between 15 and 1000 μm, preferably between 20 and 500 μm, in particular between 30 and 250 μm.

The membrane obtained in step C) or step II) is preferably self-supporting, i.e. it can be removed from the support without damage and subsequently optionally be processed further directly.

After the polymerization in step C) or step II), the membrane may be crosslinked on the surface thermally, photochemically, chemically and/or electrochemically. This curing of the membrane surface additionally improves the properties of the membrane.

In a particular aspect, the membrane may be heated to a temperature of at least 150° C., preferably at least 200° C. and more preferably at least 250° C. Preference is given to effecting the thermal crosslinking in the presence of oxygen. In this process step, the oxygen concentration is typically in the range from 5 to 50% by volume, preferably from 10 to 40% by volume, without any intention that this should impose a restriction.

The crosslinking can also be effected by the action of IR or NIR (IR=infrared, i.e. light having a wavelength of more than 700 nm; NIR=near IR, i.e. light having a wavelength in the range from approx. 700 to 2000 nm or an energy in the range from approx. 0.6 to 1.75 eV) and/or UV light. A further method is irradiation with β-rays, γ-rays and/or electron beams. The radiation dose in this case is preferably between 5 and 250 kGy, in particular from 10 to 200 kGy. The irradiation can be effected under air or under inert gas. As a result, the use properties of the membrane, especially its lifetime, are improved.

Depending on the desired degree of crosslinking, the duration of the crosslinking reaction may lie within a wide range. In general, this reaction time is in the range from 1 second to 10 hours, preferably from 1 minute to 1 hour, without any intention that this should impose a restriction.

In a particular embodiment of the present invention, the membrane, according to elemental analysis, comprises at least 3% by weight, preferably at least 5% by weight and more preferably at least 7% by weight of phosphorus, based on the total weight of the membrane.

The proportion of phosphorus can be determined by means of an elemental analysis. For this purpose, the membrane is dried at 110° C. for 3 hours under reduced pressure (1 mbar).

The polymers comprising phosphonic acid groups preferably have a content of phosphonic acid groups of at least 5 meq/g, more preferably at least 10 meq/g. This value is determined via the so-called ionic exchange capacity (IEC).

To measure the IEC, the phosphonic acid groups are converted to the free acid, the measurement being effected before polymerization of the monomers comprising phosphonic acid groups. The sample is subsequently titrated with 0.1 M NaOH. From the consumption of the acid up to the equivalence point and the dry weight, the ion exchange capacity (IEC) is then calculated.

The inventive polymer membrane has improved material properties compared to the doped polymer membranes known to date. In particular, in comparison with known doped polymer membranes, they exhibit better performances. The reason for this is in particular an improvement in proton conductivity. At temperatures of 120° C., this is at least 1 mS/cm, preferably at least 2 mS/cm, in particular at least 5 mS/cm, preferably measured without moistening.

In addition, the membranes have a high conductivity even at a temperature of 70° C. The conductivity is dependent upon factors including sulfonic acid group content of the membrane. The higher this content is, the better the conductivity at low temperatures. In this context, an inventive membrane can be moistened at low temperatures. For this purpose, for example, the compound used as the energy source, for example hydrogen, can be provided with a fraction of water. In many cases, however, even the water formed by the reaction is sufficient to achieve moistening.

The specific conductivity is measured by means of impedance spectroscopy in a 4-pole arrangement in potentiostatic mode and using platinum electrodes (wire, diameter 0.25 mm). The distance between the current-collecting electrodes is 2 cm. The resulting spectrum is evaluated with a simple model consisting of a parallel arrangement of an ohmic resistance and a capacitor. The sample cross section of the phosphoric acid-doped membrane is measured immediately before the sample is mounted. To measure the temperature dependence, the test cell is brought to the desired temperature in an oven and controlled via a Pt-100 thermoelement positioned in the immediate vicinity of the sample. After the temperature has been attained, the sample is kept at this temperature for 10 minutes before the start of the measurement.

The crossover current density in operation with 0.5 M methanol solution and at 90° C. in a so-called liquid direct methanol fuel cell is preferably less than 100 mA/cm², in particular less than 70 mA/cm², more preferably less than 50 mA/cm² and most preferably less than 10 mA/cm². The crossover current density in operation with a 2 M methanol solution and at 160° C. in a so-called gaseous direct methanol fuel cell is preferably less than 100 mA/cm², in particular less than 50 mA/cm², most preferably less than 10 mA/cm².

To determine the crossover current density, the amount of carbon dioxide which is released at the cathode is measured by means of a CO₂ sensor. From the value of the amount of CO₂ thus obtained, as described by P. Zelenay, S. C. Thomas, S. Gottesfeld in S. Gottesfeld, T. F. Fuller “Proton Conducting Membrane Fuel Cells II” ECS Proc. Vol. 98-27 p. 300-308, the crossover current density is calculated.

In addition, an inventive polymer membrane has one or two catalyst layers which are electrochemically active. The term “electrochemically active” indicates that the catalyst layer or layers are capable of catalyzing the oxidation of fuels, for example H₂, methanol, ethanol, and the reduction of O₂.

The catalyst layer or catalyst layers comprises or comprise catalytically active substances. These include noble metals of the platinum group, i.e. Pt, Pd, Ir, Rh, Os, Ru, or else the noble metals Au and Ag. In addition, alloys of all of the aforementioned metals may also be used. Furthermore, at least one catalyst layer may comprise alloys of the platinum group metals with base metals, for example Fe, Co, Ni, Cr, Mn, Zr, Ti, Ga, V, etc. In addition, it is also possible to use the oxides of the aforementioned noble metals and/or base metals.

The catalytically active particles which comprise the aforementioned substances may be used in the form of metal powder, known as noble metal black, in particular platinum and/or platinum alloys. Such particles generally have a size in the range from 5 nm to 200 nm, preferably in the range from 7 nm to 100 nm.

In addition, the metals may also be used on a support material. This support preferably comprises carbon which may be used in particular in the form of carbon black, graphite or graphitized carbon black. Moreover, it is also possible to use electrically conductive metal oxides, for example SnOₓ, TiOₓ, or phosphates, for example FePOₓ, NbPOₓ, Zr_{y}(POₓ)_{z} as the support material. In this context, the indices x, y and z indicate the oxygen or metal content of the individual compounds, which may lie within an known range, since the transition metals can assume different oxidation states.

The content of these supported metal particles based on the total weight of the metal-support compound is generally in the range from 1 to 80% by weight, preferably from 5 to 60% by weight and more preferably from 10 to 50% by weight, without any intention that this should impose a restriction. The particle size of the support, especially the size of the carbon particles, is preferably in the range from 20 to 100 nm, in particular from 30 to 60 nm. The size of the metal particles disposed thereon is preferably in the range from 1 to 20 nm, in particular from 1 to 10 nm and more preferably from 2 to 6 nm.

The sizes of the different particles constitute mean values and can be determined by means of transmission electron microscopy or powder x-ray diffractometry.

The catalytically active particles detailed above can generally be obtained commercially.

In addition, this catalyst layer comprises ionomers which comprise phosphonic acid groups and are obtainable by polymerizing monomers comprising phosphonic acid groups.

The monomers comprising phosphonic acid groups have been detailed above, so that reference is made thereto. Preference is given to ethenephosphonic acid, propenephosphonic acid, butenephosphonic acid; acrylic acid and/or methacrylic acid compounds which have phosphonic acid groups, for example 2-phosphonomethylacrylic acid, 2-phosphonomethylmethacrylic acid, 2-phosphonomethylacrylamide and 2-phosphono-methylmethacrylamide, for preparing the ionomers to be used in accordance with the invention.

Particular preference is given to using commercial vinylphosphonic acid (ethenephosphonic acid), as obtainable, for example, from Aldrich or Clariant GmbH. A preferred vinylphosphonic acid has a purity of more than 70%, in particular 90% and more preferably more than 97% purity.

In addition, the ionomers may be prepared by using monomers comprising sulfonic acid groups.

In a particular aspect of the present invention, when preparing the ionomers, mixtures of monomers comprising phosphonic acid groups and monomers comprising sulfonic acid groups in which the weight ratio of monomers comprising phosphonic acid groups to monomers comprising sulfonic acid groups is in the range from 100:1 to 1:100, preferably from 10:1 to 1:10 and more preferably from 2:1 to 1:2.

The ionomer preferably has a molecular weight in the range from 300 to 100 000 g/mol, preferably from 500 to 50 000 g/mol. This value can be determined by means of GPC.

In a particular aspect of the present invention, the ionomer may have a polydispersity M_{w}/Mₙ in the range from 1 to 20, more preferably from 3 to 10.

In addition, it is also possible to use commercially available polyvinylphosphonic acids as the ionomer. These are obtainable, inter alia, from Polysciences Inc.

In a particular embodiment of the present invention, the ionomers may have a particularly uniform distribution in the catalyst layer. This uniform distribution can be achieved in particular by the ionomers being contacted with the catalytically active substances before the catalyst layer is applied to the polymer membrane.

The uniform distribution of the ionomer in the catalyst layer can be determined, for example, by EDX. In this case, the scattering within the catalyst layer is not more than 10%, preferably 5% and more preferably 1%.

The fraction of ionomer in the catalyst layer is preferably in the range from 1 to 60% by weight, more preferably in the range from 10 to 50%.

The fraction of phosphorus according to elemental analysis in the catalyst layer is preferably at least 0.3% by weight, in particular at least 3% by weight and more preferably at least 7% by weight. In a particular aspect of the present invention, the fraction of phosphorus in the catalyst layer is in the range from 3% by weight to 15% by weight.

To apply at least one catalyst layer, various methods may be used. For example, it is possible in step C) to use a support which has been provided with a coating comprising a catalyst, in order to provide the layer formed in step C) with a catalyst layer.

In this case, the membrane may be provided with a catalyst layer on one side or both sides. When the membrane is provided with a catalyst layer only on one side, the opposite side of the membrane has to be compressed with an electrode which has a catalyst layer. If both sides of the membrane are to be provided with a catalyst layer, the methods below may also be employed in combination in order to achieve an optimal result.

According to the invention, the catalyst layer may be applied by a process in which a catalyst suspension is used. In addition, it is also possible to use powders which comprise the catalyst.

In addition to the catalytically active substance and the ionomer comprising phosphonic acid groups, the catalyst suspension may comprise customary additives. These include fluoropolymers, for example polytetrafluoroethylene (PTFE), thickeners, in particular water-soluble polymers, for example cellulose derivatives, polyvinyl alcohol, polyethylene glycol, and surface-active substances.

The surface-active substances include in particular ionic surfactants, for example fatty acid salts, in particular sodium laurate, potassium oleate; and alkylsulfonic acids, alkylsulfonate salts, in particular sodium perfluorohexanesulfonate, lithium perfluorohexanesulfonate, ammonium perfluorohexanesulfonate, perfluorohexanoic acid, potassium nonafluorobutane-sulfonate, and also nonionic surfactants, in particular ethoxylated fatty alcohols and polyethylene glycols.

In addition, the catalyst suspension may comprise constituents liquid at room temperature. These include organic solvents which may be polar or nonpolar, phosphoric acid, polyphosphoric acid and/or water. The catalyst suspension comprises preferably from 1 to 99% by weight, in particular from 10 to 80% by weight of liquid constituents.

The polar, organic solvents include in particular alcohols, such as ethanol, propanol, isopropanol and/or butanol.

The organic, nonpolar solvents include known thin film diluents, such as thin film diluent 8470 from DuPont, which comprises turpentine oils.

Particularly preferred additives are fluoropolymers, in particular tetrafluoroethylene polymers. In a particular embodiment of the present invention, the catalyst suspension may comprise from 0 to 60% fluoropolymer based on the weight of the catalyst material, preferably from 1 to 50%.

In this context, the weight ratio of fluoropolymer to catalyst material comprising at least one noble metal and optionally one or more support materials may be greater than 0.1, this ratio preferably being in the range from 0.2 to 0.6.

The catalyst suspension may be applied to the membrane by customary processes. Depending on the viscosity of the suspension, which may also be present in paste form, various methods With which the suspension may be applied are known. Suitable processes are those for coating films, fabrics, textiles and/or papers, especially spraying processes and printing processes, for example stencil printing and screenprinting, inkjet printing, roll application, especially engraved rollers, slot die application and knife-coating. The particular process and the viscosity of the catalyst suspension is dependent upon the hardness of the membrane.

The viscosity can be influenced by the solids content, especially the fraction of catalytically active particles, and the fraction of additives. The viscosity to be established depends upon the application method of the catalyst suspension, the optimal values and their determination being familiar to those skilled in the art.

Depending on the hardness of the membrane, the bonding of catalyst and membrane can be improved by heating and/or pressing. In addition, the bonding between membrane and catalyst rises as a result of an above-described surface crosslinking treatment which can be effected thermally, photochemically, chemically and/or electrochemically.

In a particular aspect of the present invention, the catalyst layer is applied with a powder process. In this process, a catalyst powder which may comprise additional additives which have been detailed above by way of example is used.

To apply the catalyst powder, it is possible to use processes including spray processes and screen processes. In the spray process, the powder mixture is sprayed onto the membrane with a die, for example a slot die. In general, the membrane provided with a catalyst layer is subsequently heated in order to improve the bond between catalyst and membrane. The heating can be effected, for example, by means of a hot roller. Such methods and apparatus for applying the powder are described, inter alia, in DE 195 09 748, DE 195 09 749 and DE 197 57 492.

In the screen process, the catalyst powder is applied to the membrane with a shaking screen. An apparatus for applying a catalyst powder to a membrane is described in WO 00/26982. After the catalyst powder has been applied, the bond of catalyst and membrane can be improved by heating. In this case, the membrane provided with at least one catalyst layer can be heated to a temperature in the range from 50 to 200° C., in particular from 100 to 180° C.

In addition, the catalyst layer may be applied by a process in which a coating comprising a catalyst is applied to a support and the coating which comprises a catalyst and is present on the support is subsequently transferred to a membrane. Such a process is described by way of example in WO 92/15121.

The support provided with a catalyst coating can be produced, for example, by producing a catalyst suspension described above. This catalyst suspension is subsequently applied to a support film, for example of polytetrafluoroethylene. After the suspension has been applied, the volatile constituents are removed.

The coating comprising a catalyst can be transferred, inter alia, by heat-pressing. For this purpose, the composite comprising a catalyst layer and a membrane and also a support film is heated to a temperature in the range from 50° C. to 200° C. and pressed at a pressure of from 0.1 to 5 MPa. In general, a few seconds are sufficient to bond the catalyst layer with the membrane. This time is preferably in the range from 1 second to 5 minutes, in particular from 5 seconds to 1 minute.

In a particular embodiment of the present invention, the catalyst layer has a thickness in the range from 1 to 1000 μm, in particular from 5 to 500, preferably from 10 to 300 μm. This value is a mean value which can be determined by measuring the layer thickness in the cross section of images which can be obtained with a scanning electron microscope (SEM).

In a particular embodiment of the present invention, the membrane provided with at least one catalyst layer comprises from 0.1 to 10.0 mg/cm², preferably from 0.2 to 6.0mg/cm² and more preferably from 0.2 to 2 mg/cm² of the catalytically active metal, for example Pt. These values may be determined by elemental analysis of a flat sample. When the membrane is to be provided with two catalyst layers opposite one another, the abovementioned values of the metal basis weight apply per catalyst layer.

In a particular aspect of the present invention, one side of a membrane has a higher metal content than the opposite side of the membrane. The metal content of one side is preferably at least twice as high as the metal content of the opposite side.

After the treatment in step C) and/or step D), the membrane may also be crosslinked in the presence of oxygen by the action of heat. This curing of the membrane additionally improves the properties of the membrane. For this purpose, the membrane may be heated to a temperature of at least 150° C., preferably at least 200° C. and more preferably at least 250° C. The oxygen concentration in this process step is typically in the range from 5 to 50% by volume, preferably from 10 to 40% by volume, without any intention that this should impose a restriction.

The crosslinking can also be effected by the action of IR or NIR (IR=infrared, i.e. light having a wavelength of more than 700 nm; NIR=near IR, i.e. light having a wavelength in the range from approx. 700 to 2000 nm and an energy in the range from approx. 0.6 to 1.75 eV). A further method is irradiation with β-rays. The radiation dose here is between 5 and 200 kGy.

Depending on the desired degree of crosslinking, the duration of the crosslinking reaction may lie within a wide range. In general, this reaction time is in the range from 1 second to 10 hours, preferably from 1 minute to 1 hour, without any intention that this should impose a restriction.

Possible fields of use of the inventive polymer membranes include use in fuel cells, in electrolysis, in capacitors and in battery systems.

The present invention also relates to a membrane-electrode unit which has at least one inventive polymer membrane. For further information on membrane-electrode units, reference is made to the technical literature, in particular to the patents U.S. Pat. No. 4,191,618, U.S. Pat. No. 4,212,714 and U.S. Pat. No. 4,333,805. The disclosure present in the aforementioned references [U.S. Pat. No. 4,191,618, U.S. Pat. No. 4,212,714 and U.S. Pat. No. 4,333,805] with regard to the construction and to the production of membrane-electrode units, and also to the electrodes to be selected, gas diffusion layers and catalysts, is also part of the description.

To produce a membrane-electrode unit, the inventive membrane may be bonded to a gas diffusion layer. If the membrane has been provided on both sides with a catalyst layer, the gas diffusion layer does not have to have a catalyst before the pressing. However, it is also possible to use gas diffusion layers provided with a catalytically active layer. The gas diffusion layer generally has electron conductivity. For this purpose, flat, electrically conductive and acid-resistant structures are typically used. These include, for example, carbon fiber papers, graphitized carbon fiber papers, carbon fiber fabric, graphitized carbon fiber fabric and/or flat structures which have been made conductive by adding carbon black.

The gas diffusion layers are bonded to the membrane provided with at least one catalyst layer by pressing the individual components under customary conditions. In general, lamination is effected at a temperature in the range from 10 to 300° C., in particular from 20° C. to 200° C., and with a pressure in the range from 1 to 1000 bar, in particular from 3 to 300 bar.

In addition, the membrane can also be bonded to the catalyst layer by using a gas diffusion layer provided with a catalyst layer. In this case, a membrane-electrode unit can be formed from a membrane without a catalyst layer and two gas diffusion layers provided with a catalyst layer.

An inventive membrane-electrode unit exhibits a surprisingly high power density. In a particular embodiment, preferred membrane-electrode units provide a current density of at least 0.05 A/cm², preferably 0.1 A/cm², more preferably 0.2 A/cm². This current density is measured in operation with pure hydrogen at the anode and air (approx. 20% by volume of oxygen, approx. 80% by volume of nitrogen) at the cathode at standard pressure (1013 mbar absolute, with open cell outlet) and cell voltage 0.6 V. It is impossible here to use particularly high temperatures in the range of 150-200° C., preferably 160-180° C., in particular of 170° C. In addition, the inventive MEU can also be used in the temperature range below 100° C., preferably of 50-90° C., in particular at 80° C. At these temperatures, the MEU exhibits a current density of at least 0.02 A/cm², preferably of at least 0.03 A/cm² and more preferably of 0.05 A/cm², measured at a voltage of 0.6 V under the other conditions mentioned above.

The aforementioned power densities may also be achieved at lower stoichiometry of the fuel gas. In a particular aspect of the present invention, the stoichiometry is less than or equal to 2, preferably less than or equal to 1.5, most preferably less than or equal to 1.2. The oxygen stoichiometry is less than or equal to 3, preferably less than or equal to 2.5 and more preferably less than or equal to 2.

### EXAMPLE 1

Example 1 shows a polarization curve of a membrane-electrode unit consisting of a phosphonic acid-containing membrane and two electrodes. This example serves as a reference example for examples 2 and 3. The preparation of the individual components is described below:

Membrane: A film of high molecular weight polybenzimidazole which has been prepared from a PBI-DMAc solution according to DE 10052237.8 and by selection of suitable polymer granule according to DE 10129458.1 is first washed at 45° C. over 30 min as described in DE10110752.8. Subsequently, excess water is dabbed off with a paper towel from the PBI film thus pretreated. This undoped PBI film is then placed into a solution consisting of 1 part by weight of water and 10 parts by weight of vinylphosphonic acid (97%) obtainable from Clariant at 70° C. over 2 h. The thickness increase and the surface area increase are then determined. The membrane is then treated by means of electron irradiation and an irradiation dose of 50-80 kGy. The content of vinylphosphonic acid in the membrane thus obtained is calculated by means of titration as n(VPA)/n(PBI).

Electrodes: The anode and cathode used are commercial PTFE-bonded electrodes with in each case a Pt content of 1 mg/cm², a carbon-supported Pt catalyst (30% Pt on Vulcan XC72) having been used in the catalyst layer. Neither electrode comprises any ionomer.

Production of the membrane-electrode unit: The electrodes were each placed on one side of the membrane and pressed at a temperature in the range of 100-180° C.

Polarization measurement: The measurement is effected in a single fuel cell (active surface area 50 cm²) at a temperature of 160° C. with hydrogen (24.1 L/h) as the anode gas and air as the cathode gas (99.3 L/h). The reaction gases are not moistened. Owing to the non-ionomer-containing electrode and the associated poor utilization of the catalyst, the cell power achieved at 0.6 V is only approx. 12 mW/cm².

### EXAMPLE 2

Example 2 shows three polarization curves of a membrane-electrode unit consisting of a phosphonic acid-containing membrane and two electrodes. The preparation of the individual components is described below:

Membrane: See description in example 1.

Electrodes: The anode and cathode used are commercial PTFE-bonded electrodes with in each case a Pt content of 1 mg/cm², a carbon-supported Pt catalyst (30% Pt on Vulcan XC72) having been used in the catalyst layer. A solution of 5% vinylphosphonic acid in ethanol is sprayed at 150° C. onto the particular catalyst layer of the electrodes up to a vinyl-phosphonic acid loading of 0.5 mg/cm². The electrodes are subsequently dried at 100° C.

Production of the membrane-electrode unit: The electrodes were each placed on one side of the membrane and pressed at a temperature in the range of 100-180° C.

Polarization measurement: The measurement is effected in a single fuel cell (active surface area 50 cm²) with hydrogen (24.1 L/h) as the anode gas and air as the cathode gas (99.3 L/h). The reaction gases are not moistened. Curve A in example 2 shows a polarization curve at 160° C. Subsequently, the fuel cell was cooled to 80° C. and curve B was recorded after 24 hours. Subsequently, the fuel cell was heated again to 160° C. and curve C was recorded after a further 24 hours. Example 2 shows a significant line improvement in comparison to example 1, i.e. a power of 130 mW/cm² is achieved at 160° C. and 0.6 V. At 80° C. and 0.6 V, a cell power of 36 mW/cm² is achieved. As a result of the good bonding of the ionomer in the catalyst layer, example 2 makes clear that the membrane-electrode unit produced in this way is temperature cycle-stable. This property is evident by a comparison of curves A and C.

### EXAMPLE 3

Example 3 shows three polarization curves of a membrane-electrode unit consisting of a phosphonic acid-containing membrane and two electrodes. The preparation of the individual components is described below:

Membrane: See description in example 1.

Electrodes: The anode and cathode used are commercial PTFE-bonded electrodes with in each case a Pt content of 1 mg/cm², a carbon-supported Pt catalyst (30% Pt on Vulcan XC72) having been used in the catalyst layer. A solution of polyvinylphosphonic acid, 1-propanol and water (weight ratio 1:4:2) is applied at room temperature with a brush to the particular catalyst layer of the electrodes. The polyvinylphosphonic acid (PVPA) content of the catalyst layers is in each case 2.4 mg/cm². Thereafter, the electrodes are dried at 100° C.

The polyvinylsulfonic acid is prepared by free-radical polymerization using an azo initiator. In this preparation, a defined amount of vinylphosphonic acid monomer, preferred manufacturer Clariant (purity min. 90%), is reacted with heating in a semi-open system with addition of 1% by wt. of an azo initiator, preferably 2,2-azobis(isobutyramidine)dihydro-chloride from Aldrich. The mixture is heated first to a temperature of 60° C. for 30 min and then to a temperature of 80° C. for a further 30 min. After this time, the reaction should be complete, which is indicated by the absence of bubble formation. The molecular weight of the PVPA prepared by free-radical polymerization was determined by means of a commercial standard, preferably PVPA from PSS (Mainz, Germany), (polyvinylsulfonic acid, Mw=20 000 g/mol according to manufacturer data) and gel permeation chromatography with an eluent of water and acetonitrile with addition of NaNO₃. The intensities measured for individual elution volumes are evaluated with reference to a calibration curve based on pullulan. The unit used consists of a pump from Bischoff, a Suprema 100 column (pore sizes from 1e3 to 3e3) from PSS (Mainz) and a Shrodex RI-71 infrared detector. Measurement was effected at a column temperature of T=35° C., a sample concentration of c=3.5 mg/l (injection volume 100 μl) at a flow rate of 1 ml/min. In this way, the molecular weight of the commercial PVPA was determined to be Mw=33 100 g/mol (Mn=22 550 g/mol) and that of the PVPA prepared by means of free-radical polymerization to be Mw=26 600 g/mol (Mn=16 800 g/mol).

Production of the membrane-electrode unit: The electrodes were each placed on one side of the membrane and pressed at a temperature in the range of 100-2180° C.

Polarization measurement: The measurement is effected in a single fuel cell (active surface area 50 cm²) with hydrogen (24.1 L/h) as the anode gas and air as the cathode gas (99.3 L/h). The reaction gases are not moistened. Curve D in example 3 shows a polarization curve at 160° C. Subsequently, the fuel cell was cooled to 80° C. and curve E was recorded after 24 hours. Subsequently, the fuel cell was heated again to 160° C. and curve F was recorded after a further 24 hours. Example 3 shows a significant line improvement in comparison to example 1, i.e. a power of 120 mW/cm² is achieved at 160° C. and 0.6 V. At 80° C. and 0.6 V, a cell power of 36 mW/cm² is achieved. As a result of the good bonding of the ionomer in the catalyst layer, example 3 makes clear that the membrane-electrode unit produced in this way is temperature cycle-stable. This property is evident by a comparison of curves D and F.

1-26. (canceled)

27. A proton-conducting polymer membrane coated with a catalyst layer, said polymer membrane comprising polymers which comprise phosphonic acid groups and are obtainable by polymerizing monomers comprising phosphonic acid groups, characterized in that the catalyst layer comprises ionomers which comprise phosphonic acid groups and are obtainable by polymerizing monomers comprising phosphonic acid groups.

28. The polymer membrane as claimed in claim 27, characterized in that the membrane comprises at least 7% by weight of polymers comprising phosphonic acid groups.

29. The polymer membrane as claimed in claim 27, characterized in that at least one catalyst layer comprises at least 3% by weight of phosphorus.

30. The polymer membrane as claimed in claim 27, characterized in that the polymers comprising phosphonic acid groups and/or ionomers comprising phosphonic acid groups are prepared by using a monomer comprising phosphonic acid groups of the formula
]_{y}-R—(PO₃ Z₂)ₓ
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10
y is an integer of 1, 2, 3, 4, 5, 6, 7, 8, 9 or 10
and/or of the formula
ₓ(Z₂O₃P)—RR—(PO₃Z₂)ₓ
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10
and/or of the formula
R—(PO₃Z₂)ₓ
in which
A is a group of the formulae COOR2, CN, CONR22, OR2 and/or R2, in which R2 is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ2,
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10.

31. The polymer membrane as claimed in claim 27, characterized in that the polymers comprising phosphonic acid groups and/or ionomers comprising phosphonic acid groups are prepared by using a monomer comprising sulfonic acid groups of the formula
]_{y}-R—(SO₃Z)ₓ
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10
y is an integer of 1, 2, 3, 4, 5, 6, 7, 8, 9 or 10
and/or of the formula
ₓ(ZO₃S)—RR—(SO₃Z)ₓ
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10
and/or of the formula
R—(SO₃Z)ₓ
in which
A is a group of the formulae COOR², CN, CONR²₂, OR² and/or R², in which R² is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ2,
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10.

32. The polymer membrane as claimed in claim 27, characterized in that the ionomer has a molecular weight in the range from 300 to 100 000 g/mol.

33. The polymer membrane as claimed in claim 27, characterized in that the ionomer has a polydispersity M_{w}/Mₙ in the range from 3 to 10.

34. The polymer membrane as claimed in claim 27, characterized in that the membrane comprises at least one polymer (B) which is different from the polymer comprising phosphonic acid groups.

35. The polymer membrane as claimed in claim 27, characterized in that the polymers comprising phosphonic acid groups are crosslinked thermally, photochemically, chemically and/or electrochemically.

36. The polymer membrane as claimed in claim 35, characterized in that the polymers comprising phosphonic acid groups are prepared by using crosslinking monomers.

37. The polymer membrane as claimed in claim 27, characterized in that the polymer membrane has a thickness in the range of 20 and 4000 μm.

38. The polymer membrane as claimed in claim 34, characterized in that the catalyst layer has a thickness in the range of 1-1000 μm.

39. The polymer membrane as claimed in claim 38, characterized in that the catalyst layer comprises a catalyst whose active particles have a size in the range of 1-200 nm.

40. The polymer membrane as claimed in claim 27, characterized in that the polymer membrane comprises 0.1-10 mg/cm² of a catalytically active substance.

41. The polymer membrane as claimed in claim 40, characterized in that the catalytically active substance comprises particles which comprise platinum, palladium, gold, rhodium, iridium and/or ruthenium.

42. The polymer membrane as claimed in claim 41, characterized in that the catalyst comprises particles which comprise carbon.

43. A process for producing a polymer membrane as claimed in claim 27, comprising the steps of
A) preparing a composition comprising monomers comprising phosphonic acid groups,
B) applying a layer using the composition according to step A) on a support,
C) polymerizing the monomers comprising phosphonic acid groups present in the flat structure obtainable according to step B),
D) applying at least one catalyst layer to the membrane formed in step B) and/or in step C).

44. A process for producing a polymer membrane as claimed in claim 27, comprising the steps of:
I) swelling a polymer film with a liquid which comprises monomers comprising phosphonic acid groups,
II) polymerizing at least some of the monomers comprising phosphonic acid groups which have been introduced into the polymer film in step I) and
III) applying at least one catalyst layer to the membrane formed in step II).

45. The process as claimed in claim 43, characterized in that the catalyst layer is applied by a powder process.

46. The process as claimed in claim 43, characterized in that the catalyst layer is applied by a process in which a catalyst suspension is used.

47. The process as claimed in claim 46, characterized in that the catalyst suspension comprises at least one organic, nonpolar solvent.

48. The process as claimed in claim 45, characterized in that the catalyst layer is applied in step D) by a process in which a coating comprising a catalyst is applied to a support and the coating which comprises a catalyst and is present on the support is subsequently transferred to the membrane.

49. The process as claimed in claim 48, characterized in that the coating comprising a catalyst is transferred by heat-pressing.

50. The process as claimed in claim 43, characterized in that the catalyst layer applied to the membrane is bonded to a gas diffusion layer.

51. A membrane-electrode unit comprising at least one membrane as claimed in claim 27.

52. A fuel cell comprising one or more membrane-electrode units as claimed in claim 51.
